(19) United States
(12) Patent Application Publication
(10) Pub. No.: US 2011/0040652 A1
(43) Pub. Date: Feb. 17, 2011

(54) E-business items assignment management method and system

(76) Inventor: Nankuei Lin, Taipei (TW)

Correspondence Address: SAM CHEN, 7F-1, 293, ROOSEVELT ROAD, SEC 3, TAIPEI, TW

(21) Appl. No.: 12/540,375

(22) Filed: Aug. 13, 2009

(51) Int. Cl. G06Q 30/00

(52) U.S. Cl. 705/27.1

(57) ABSTRACT

An e-business items assignment management system includes a plurality of e-business platforms; a work platform; and a plurality of web page servers. Each e-business platform includes a platform server and is connected to the Internet so that one of a plurality of remote terminals may access to the Internet for operating the e-business platform. The platform servers and the web page servers are interconnected via the work platform. E-business items assignment management methods are also provided.

### BACKGROUND OF THE INVENTION

1. Field of Invention

The invention relates to e-business and more particularly to an e-business items assignment management method and system.

2. Description of Related Art

A blog is a type of personal diary posted on the Internet. Most blogs consist of small, plentiful entries. Topics posted on blogs may vary widely.

Conventionally, e-business is impossible by means of blog. This is because only data such as pictures and documents are typically transmitted by a web server. High cost and technological difficulties make e-business using blog almost infeasible.

Currently, there are many websites providing online shopping. Typically, an item and a brief description thereof are shown on a web page. Hence, a would-be buyer may not know details of a desired item by simply viewing the web page. This may greatly decrease interest of many would-be buyers. Many restrictions are also imposed on web pages provided by the online auction and shopping websites. This can further frustrate many would-be buyers. Thus, it is desirable to provide a novel e-business items assignment management method and system in order to overcome the inadequacies of the prior art.

### SUMMARY OF THE INVENTION

It is therefore one object of the invention to provide an e-business items assignment management system.

It is another object of the invention to provide an e-business items assignment management method for use in the e-business items assignment management system.

The above and other objects, features and advantages of the invention will become apparent from the following detailed description taken with the accompanying drawings.

### BRIEF DESCRIPTION OF THE DRAWINGS

FIG. 1 is a block diagram of an e-business items assignment management system according to the invention;

FIG. 2 is a block diagram of a first preferred embodiment of e-business items assignment management system according to the invention;

FIG. 3 is a detailed block diagram of the web page server of FIG. 2;

FIG. 4 is a block diagram of the home page of the blog according to the first preferred embodiment of the invention;

FIG. 5 is a block diagram of the blog items assignment management module of FIG. 4;

FIG. 6 is a block diagram of a second preferred embodiment of e-business items assignment management system according to the invention;

FIG. 7 is a detailed block diagram of the e-business platform of FIG. 6;

FIG. 8 is a block diagram of the home page of the e-business platform according to the second preferred embodiment of the invention; and

FIG. 9 is a block diagram of the sales group items assignment module of FIG. 8.

### DETAILED DESCRIPTION OF THE INVENTION

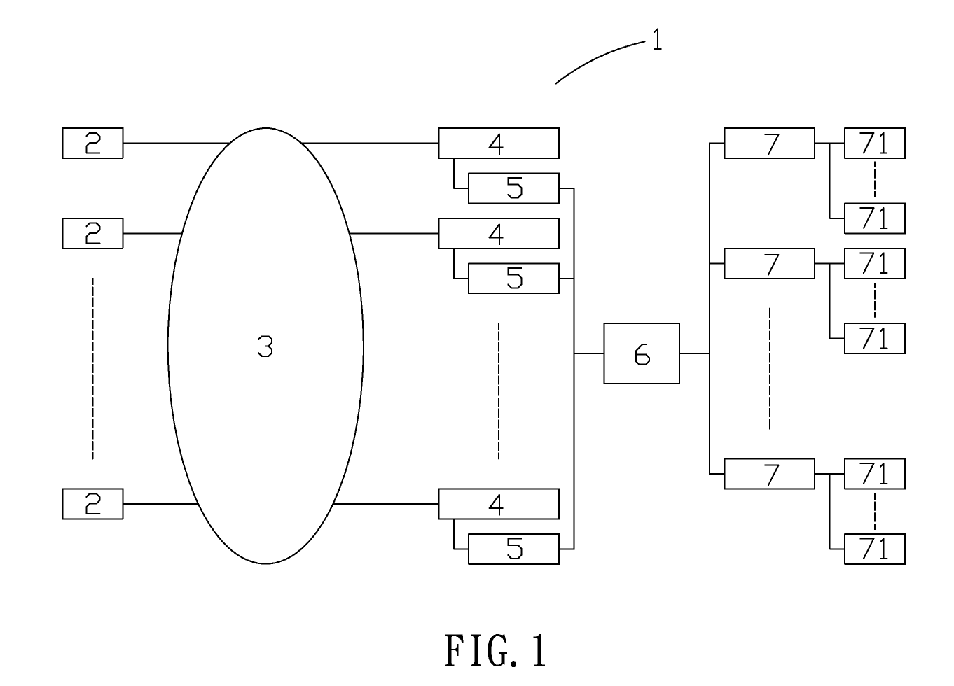

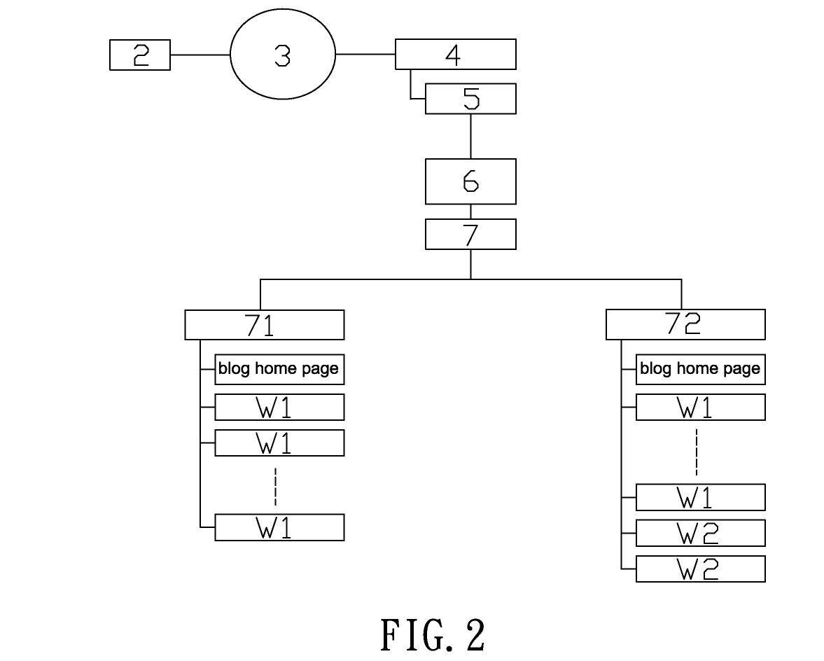

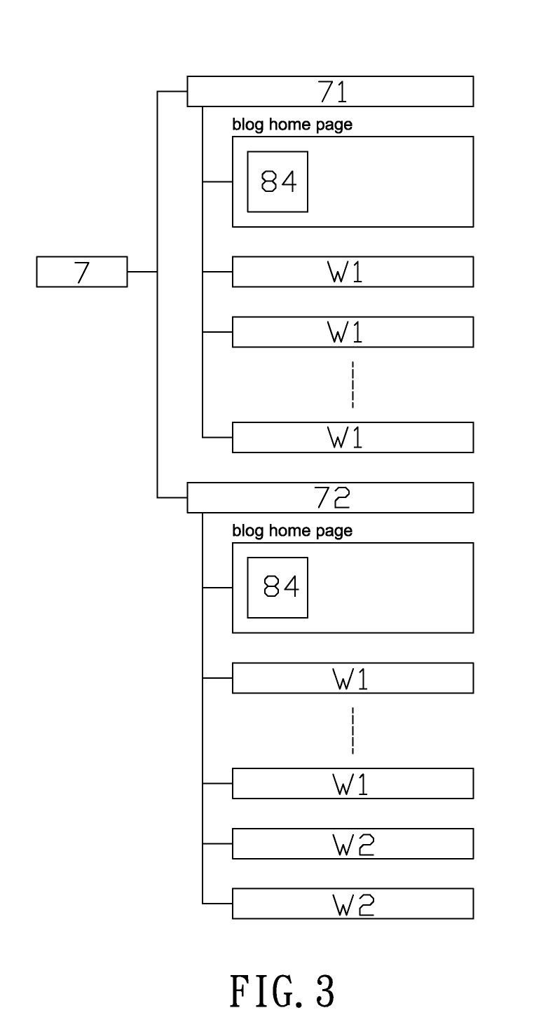

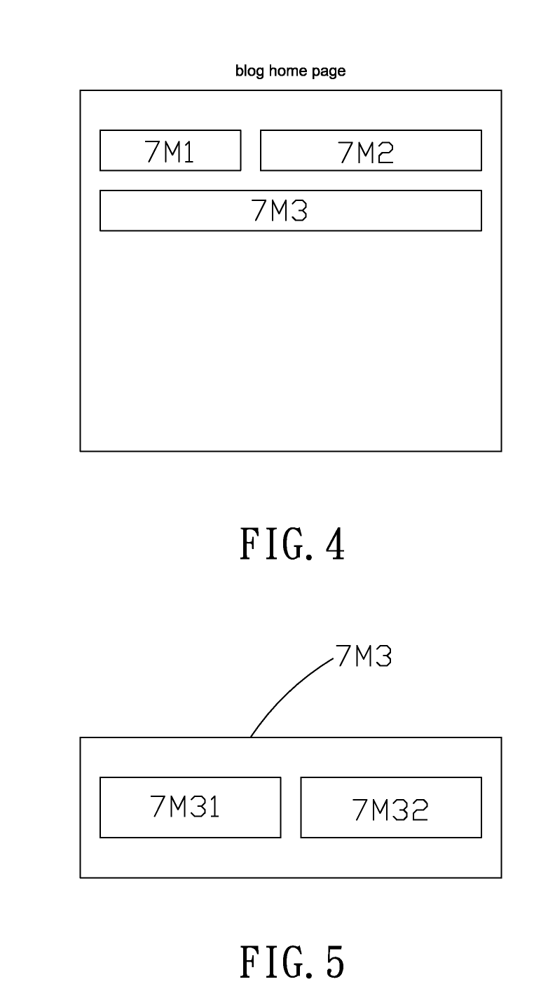

Referring to FIGS. 1 to 5, a first preferred embodiment of the invention is illustrated.

An e-business items assignment management system 1 comprises a plurality of e-business platforms 4, a work platform 6, and a plurality of web page servers 7. The e-business platform 4 comprises a platform server 5. Each platform server 5 is connected to the Internet 3 via the e-business platform 4. The Internet 3 is in turn connected to a plurality of remote terminals 2 for data communications. The platform servers 5, the work platform 6, and the web page servers 7 are interconnected for data communications.

An e-business items assignment management method for use in the e-business items assignment management system 1 comprises connecting a user of the remote terminal 2 to the Internet 3 which is in turn connected to the platform server 5 via the e-business platform 4; typing personal data of the user on the remote terminal 2 to apply for membership of the e-business platform 4; and allowing the user to access the e-business platform 4 after successfully obtaining the membership of the e-business platform 4.

A seller is required to register with the e-business platform 4 in order to obtain a salesperson membership of the e-business platform 4. That is, a seller having the salesperson membership is regarded as a salesperson.

A seller having the salesperson membership may register with the e-business platform 4. Next, the platform server 5 associated with the e-business platform 4 will be connected to the web page server 7 via the work platform 6. Next, one or more web pages of a blog 71 about the seller will be created by the web page server 7. An item description page W1 about each item to be sold by the seller will be created by the blog 71. Details including pictures and detailed description of the item are also included in the item description page W1 so that a person may link same for retrieving information therefrom.

The e-business items assignment management method further comprises a blog items interactive mode including creating a blog module 7M1 on the blog 71 of the salesperson. Thus, the salesperson may have the right of using the blog module 7M1. The salesperson associated with the e-business platform 4 may create an association blog 72 for the blog of another salesperson by setting the blog module 7M1.

The blog items interactive mode further comprises causing the e-business platform 4 to create a plurality of blog items display links on the web pages of the blog 71 of the salesperson. The blog items display link comprises a plurality of links each connecting to pictures and detailed description of a corresponding item description page W1 belonging to the association blog 72 of the salesperson.

The e-business items assignment management method further comprises a blog items management mode including creating a blog items management module 7M2 on the blog 71 of the salesperson. Thus, the salesperson may have the right of using the blog items management module 7M2. A salesperson associated with the e-business platform 4 may link pictures and detailed description of an item description page W1 belonging to the blog 71 of the salesperson with a corresponding item description page W1 by setting the blog items management module 7M2. Thereafter, a plurality of blog items display links on the web pages of the blog 71 of the salesperson (or the association blog 72 of the salesperson) can be created.

The blog items management mode further comprises allowing a salesperson to set the blog items management module 7M2 to submit a joint sale application if the salesperson wants to place the item description page W1 of the blog 71 thereof on the blog items display link of the web pages of the association blog 72 of the salesperson. Next, the salesperson of the association blog 72 may allow the joint sale application or not based on the setting of the blog items management module 7M2. The salesperson of the association blog 72 will do the following things if the joint sale application is allowed. The use status of the item description page W1 of the blog 71 of the salesperson will be set as joint sale application confirmation status. Moreover, the item description page W1 of the blog 71 of the salesperson will be combined with the web pages of the association blog 72 of the salesperson to create a joint sale item description page W2. The salesperson owning the association blog 72 may link pictures and detailed description of a joint sale item description page W2 belonging to the association blog 72 of the salesperson with a corresponding joint sale item description page W2. Further, a link is created on the blog items display link of the web pages of the association blog 72 of the salesperson.

The blog items display link is directed to an item joint sale link 84. A user may select the item joint sale link 84 to access pictures and detailed description of a joint sale item description page W2 belonging to the blog 71 of the salesperson. Thus, all items sold by the salesperson owning the association blog 72 can be assigned to the specific salesperson for sale with detailed description about the items being shown.

The e-business items assignment management method further comprises a blog items assignment management mode including creating a blog items assignment management module 7M3 on the blog 71 of the salesperson. Thus, the salesperson may have the right of using the blog items assignment management module 7M3 and is entitled as sales manager. The sales manager may assign items to be sold to salespersons owning at least one association blog 72 by setting the blog items assignment management module 7M3. Thus, the salespersons owning at least one association blog 72 may have own the right of selling the items. Hence, the salesperson can sell these items on web pages of his or her blog 71. Alternatively, the sales manager may refuse to let salespersons owning at least one association blog 72 have the right of selling the items by setting the blog items assignment management module 7M3. Further, the sales manager may assign the items to be sold to salespersons owning other association blogs 72 by setting the blog items assignment management module 7M3.

A single item can be assigned to salespersons owning at most m association blogs 72 (m being an integer more than one) for selling in the blog items assignment management mode.

The blog items assignment management mode further comprises an items management module 7M31 and a sales employee management module 7M32. The items management module 7M31 may be activated to link a sold item with the salesperson who sold it with relevant details being shown on the web page. The sales employee management module 7M32 may be activated to link active salespersons based on sales records.

The blog items assignment management mode further comprises a web page for setting the items management module 7M31. The web page can be activated to perform the following things: A sales manager may assign items to a salesperson for selling or revoke same and reassign the items to salespersons owning other association blogs 72. A sales manager may allow items to be shown on a blog 71 of a salesperson or not. Finally, a sales manager may allow the showing of personal data of a salesperson owning the blog 71 or hide same.

The blog items assignment management mode further comprises a web page for setting the sales employee management module 7M32. The web page can be activated to perform the following thing: A sales manager may allow a salesperson to have the right of selling items or revoke same and allow another salesperson to have the right of selling items on his or her association blog 72.

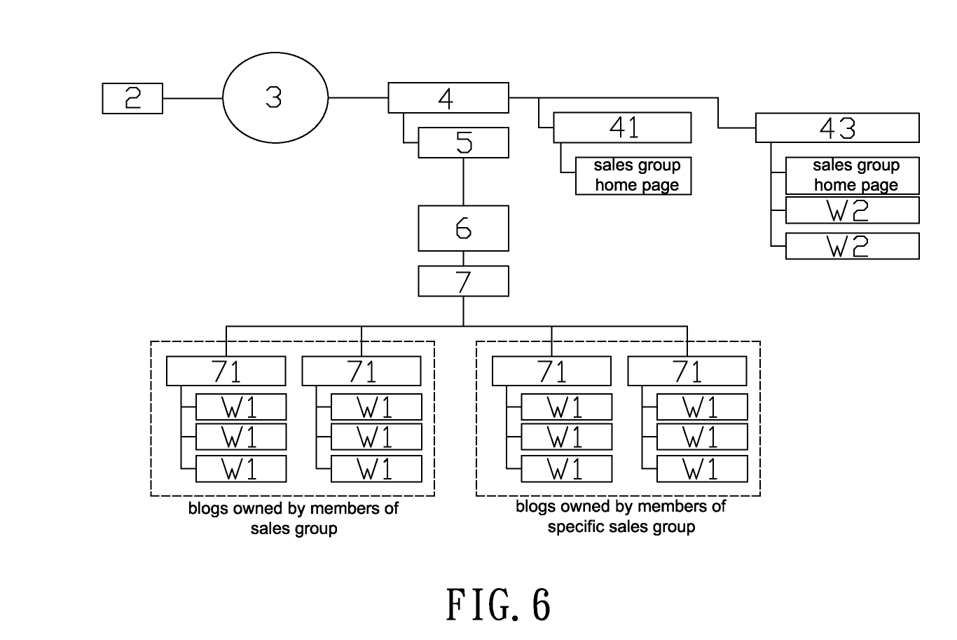

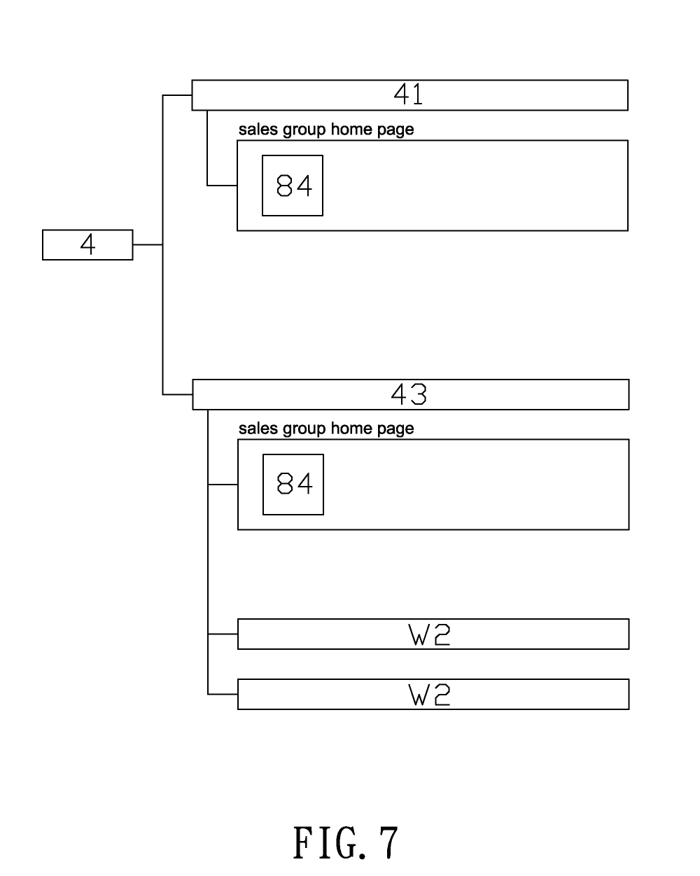

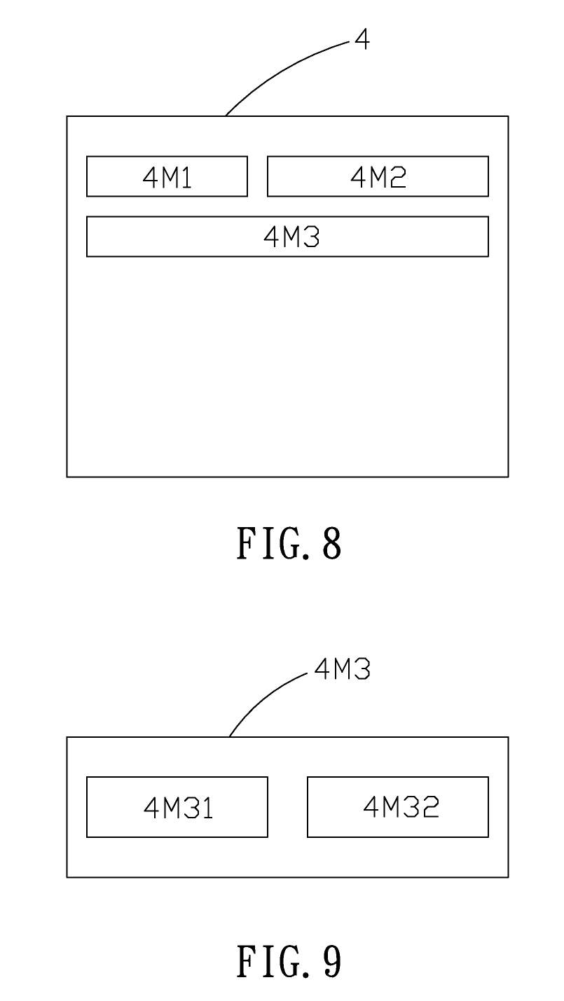

Referring to FIGS. 1 and 6 to 9, a second preferred embodiment of the invention is illustrated.

An e-business items assignment management system 1 comprises a plurality of e-business platforms 4, a work platform 6, and a plurality of web page servers 7. The e-business platform 4 comprises a platform server 5. Each platform server 5 is connected to the Internet 3 via the e-business platform 4. The Internet 3 is in turn connected to a plurality of remote terminals 2 for data communications. The platform servers 5, the work platform 6, and the web page servers 7 are interconnected for data communications.

An e-business items assignment management method for use in the e-business items assignment management system 1 comprises connecting a user of the remote terminal 2 to the Internet 3 which is in turn connected to the platform server 5 via the e-business platform 4; typing personal data of the user on the remote terminal 2 to apply for membership of the e-business platform 4; and allowing the user to access the e-business platform 4 after successfully obtaining the membership of the e-business platform 4.

A seller is required to register with the e-business platform 4 in order to obtain a salesperson membership of the e-business platform 4. That is, a seller having the salesperson membership is regarded as a salesperson.

A seller having the salesperson membership may register with the e-business platform 4. Next, the platform server 5 associated with the e-business platform 4 will be connected to the web page server 7 via the work platform 6. Next, one or more web pages of a blog 71 about the seller will be created by the web page server 7. An item description page W1 about each item to be sold by the seller will be created by the blog 71. Details including pictures and detailed description of the item are also included in the item description page W1 so that a person may link same for retrieving information therefrom.

The e-business items assignment management method further comprises a sales group mode including creating a sales group module 4M1 on the e-business platform 4. Thus, the salesperson may have the right of using the sales group module 4M1. The salespersons associated with the e-business platform 4 may create a sales group 41 by setting the sales group module 4M1. One of the salespersons is assigned as the manager of the sales group. Other salespersons may join the sales group as members by setting the sales group module 4M1. The members of the sales group are also members of the sales group associated with the e-business platform 4.

The salespersons associated with the e-business platform 4 may join one or more sales groups 41 by setting the sales group module 4M1. Alternatively, another sales group 41 can be created by the salespersons associated with the e-business platform 4 The salespersons associated with the e-business platform 4 and having the memberships of the sales group are members of the sales group. The sales groups associated with the e-business platform 4 may assign another sales group as an association sales group 42 by setting the sales group module 4M1.

The sales group mode further comprises causing the e-business platform 4 to create a plurality of group items display links associated with a sales group 41 on the web pages of the e-business platform 4. The group items display link comprises a plurality of links each connecting to pictures and detailed description of a corresponding item description page W1 belonging to the blog of a member of a sales group or an association sales group.

The e-business items assignment management method further comprises a group items management mode including creating a sales group items management module 4M2 on the e-business platform 4. Thus, members of the sales group may have the right of using the sales group items management module 4M2. A member of the sales group associated with the e-business platform 4 may link pictures and detailed description of an item description page W1 belonging to the blog 71 of the member of the sales group with a corresponding item description page W1 by setting the sales group items management module 4M2. Thereafter, a plurality of group items display links on the web pages of the e-business platform 4 can be created.

The sales group items management mode further comprises allowing a member of the sales group to set the sales group items management module 4M2 in order to submit a joint sale application if the member of the sales group wants to place the item description page W1 of the blog 71 thereof on the group items display link of a specific sales group 43 on the web pages of the e-business platform 4. Next, the manager of the specific sales group 43 may allow the joint sale application or not based on the setting of the sales group items management module 4M2. The manager of the specific sales group 43 will do the following things if the joint sale application is allowed. The use status of the item description page W1 of the blog 71 of the member of the sales group will be set as joint sale application confirmation status. Moreover, the item description page W1 of the blog 71 of the member of the sales group will be combined with the web pages of the specific sales group 43 to create a joint sale item description page W2 on the e-business platform 4.

Pictures and detailed description of a joint sale item description page W2 belonging to the specific sales group 43 on the web pages of the e-business platform 4 may be linked with a corresponding joint sale item description page W2. Further, a link is created on the group items display link of the specific sales group 43 on the web pages of the e-business platform 4.

The group items display link comprises an item joint sale link 84. A user may select the item joint sale link 84 to access pictures and detailed description of a joint sale item description page W2 belonging to the blog 71 of the member of the sales group 41. Thus, all items sold by members of other sales groups can be assigned to the sales group 41 for sale with detailed description about the items being shown.

The e-business items assignment management method further comprises a group items assignment management mode including creating a sales group items assignment module 4M3 on the e-business platform 4. Only members of the sales group have the right of using the sales group items assignment module 4M3. A member of a sales group 41 may assign items to be sold to members of another sales groups 41 who thus have the right of selling the items on the web pages. To the contrary, a member of a sales group 41 may revoke the sales right of another sales groups 41 by setting the sales group items assignment module 4M3.

Further, the member of the sales group 41 may assign items to be sold to members of still another sales group 41 again by setting the sales group items assignment module 4M3.

A single item can be assigned to at most m sales groups 41 (m being an integer more than one) for selling in the group items assignment management mode.

The group items assignment management mode further comprises a sales group items assignment module 4M31 and a sales employee management module 4M32. The sales group items assignment module 4M31 may be activated to link a sold item with the salesperson who sold it with relevant details being shown on the web page. The sales employee management module 4M32 may be activated to link active salespersons based on sales records.

The group items assignment management mode further comprises a web page for setting the sales group items assignment module 4M31. The web page can be activated to perform the following things: A sales manager may assign items to a member of a sales group 41 for selling or revoke same and reassign the items to members of another sales groups 41. A sales manager may allow items to be shown on a blog 71 of a member of a sales group 41 or not. Finally, a sales manager may allow the showing of personal data of a member of a sales group 41 owning the blog 71 or hide same.

The group items assignment management mode further comprises a web page for setting the sales employee management module 4M32. The web page can be activated to perform the following thing: A sales manager may allow a member of a sales group 41 to have the right of selling items or revoke same and allow a member of another sales group 41 to have the right of selling items.

While the invention herein disclosed has been described by means of specific embodiments, numerous modifications and variations could be made thereto by those skilled in the art without departing from the scope and spirit of the invention set forth in the claims.

What is claimed is:

1. An e-business items assignment management method for use in an e-business items assignment management system comprising a plurality of e-business platforms, a work platform, and a plurality of web page servers wherein each of the e-business platforms comprises a platform server and is connected to the Internet so that one of a plurality of remote terminals may access to the Internet for operating the e-business platform, and the platform servers and the web page servers are interconnected via the work platform, the e-business items assignment management method comprising:
connecting a user of the remote terminal to the Internet;
sending personal data of the user to the e-business platform for applying for membership of the e-business platform;
activating a blog items interactive mode including creating a blog module on the blog of a salesperson, allowing the salesperson to use the blog module, and allowing the salesperson associated with the e-business platform to create an association blog for the blog of another salesperson by setting the blog module; and
activating a blog items management mode including creating a blog items management module on the blog of the salesperson, allowing the salesperson to use the blog items management module, allowing the salesperson associated with the e-business platform to link pictures and a detailed description of an item description page belonging to the blog of the salesperson with a corresponding item description page by setting the blog items management module, and creating a plurality of blog items display links on the blog of the salesperson.

2. The e-business items assignment management method of claim 1, wherein the blog items interactive mode further comprises causing the e-business platform to create a plurality of blog items display links on the blog of the salesperson, each of the blog items display links comprising a plurality of links each connecting to pictures and a detailed description of a corresponding item description page belonging to the association blog of the salesperson.

3. The e-business items assignment management method of claim 1, wherein the blog items management mode further comprises allowing the salesperson to set the blog items management module to submit a joint sale application if the salesperson wants to connect the item description page of the blog of the salesperson to the blog items display link of the association blog of the salesperson.

4. The e-business items assignment management method of claim 1, further comprising a blog items assignment management mode including creating a blog items assignment management module on the blog of the salesperson, allowing the salesperson to use the blog items assignment management module and entitle the salesperson as a sales manager, and allowing the sales manager to either assign or not assign items to the salesperson owning the association blog for sale by setting the blog items assignment management module.

5. The e-business items assignment management method of claim 4, wherein the blog items assignment management mode further comprises an items management module, a sales employee management module, a web page for setting the items management module to either assign items to the salesperson owning the association blog or not, and a web page for setting the sales employee management module to either assign items to another salesperson owning a different association blog or not.

6. An e-business items assignment management method for use in an e-business items assignment management system comprising a plurality of e-business platforms, a work platform, and a plurality of web page servers wherein each of the e-business platforms comprises a platform server and is connected to the Internet so that one of a plurality of remote terminals may access to the Internet for operating the e-business platform, and the platform servers and the web page servers are interconnected via the work platform, the e-business items assignment management method comprising:
connecting a user of the remote terminal to the Internet;
sending personal data of the user to the e-business platform for applying for membership of the e-business platform;
activating a sales group mode including creating a sales group module on the e-business platform, allowing a salesperson to use the sales group module, allowing the salesperson associated with the e-business platform to create a sales group by setting the sales group module, entitling the salesperson as a sales manager of the sales group, allowing other salespersons to join the sales group as members of the sales group by setting the sales group module, and allowing the sales manager associated with the e-business platform to assign another sales group as an association sales group by setting the sales group module;
activating a group items management mode including creating a sales group items management module on the e-business platform, allowing the members of the sales group to use the sales group items management module, allowing the member of the sales group associated with the e-business platform to link pictures and a detailed description of an item description page belonging to the blog of the member of the sales group with a corresponding item description page by setting the sales group items management module, and creating a plurality of group items display links on web pages of the e-business platform; and
activating a group items assignment management mode including creating a sales group items assignment module on the e-business platform, allowing the members of the sales group to use the sales group items assignment module, and allowing the member of the sales group to assign items to the members of another sales group or not.

7. The e-business items assignment management method of claim 6, wherein the sales group items management mode further comprises allowing the member of the sales group to set the sales group items management module to submit a joint sale application if the member of the sales group wants to connect the item description page of the blog of the member of the sales group to the group items display link of a predetermined sales group on the web pages of the e-business platform, causing the sales manager of the predetermined sales group to decide whether to allow the joint sale application or not based on the setting of the sales group items management module, linking pictures and a detailed description of a joint sale item description page belonging to the predetermined sales group on the web pages of the e-business platform with a corresponding joint sale item description page, and creating a plurality of group items display links of the predetermined sales group on the web pages of the e-business platform.

8. The e-business items assignment management method of claim 6, wherein the group items assignment management mode further comprises a sales group items assignment module, a sales employee management module, a web page for setting the sales group items assignment module to either assign items to the member of the sales group or not, and a web page for setting the sales employee management module to either assign items to the member of the sales group or not.

9. An e-business items assignment management system comprising:
a plurality of e-business platforms;
a work platform; and
a plurality of web page servers,
wherein each of the e-business platforms comprises a platform server and is connected to the Internet so that one of a plurality of remote terminals may access to the Internet for operating the e-business platform; and
wherein the platform servers and the web page servers are interconnected via the work platform.
